(19) United States
(12) Patent Application Publication
(10) Pub. No.: US 2023/0060984 A1
(43) Pub. Date: Mar. 2, 2023

(54) ADJUSTABLE POWER INTERFACE FOR MAXIMIZING CONVERTER EFFICIENCY

(71) Applicant: Cirrus Logic International Semiconductor Ltd., Edinburgh (GB)

(72) Inventors: Ivan PERRY, Penicuik (GB); Ilija JERGOVIC, Austin, TX (US)

(73) Assignee: Cirrus Logic International Semiconductor Ltd., Edinburgh (GB)

(21) Appl. No.: 17/669,978

(22) Filed: Feb. 11, 2022

Related U.S. Application Data
(60) Provisional application No. 63/239,669, filed on Sep. 1, 2021.

(51) Int. Cl. H02J 7/00; H02J 50/10; H02M 3/158; H02J 50/80

(52) U.S. Cl. CPC H02J 7/00712; H02J 50/10; H02J 7/00304; H02M 3/158; H02J 50/80; H02J 2207/20

(57) ABSTRACT

A charging integrated circuit for use in an electronic device may include an input interface configured to receive input electrical energy from a power supply, wherein the input interface is controllable to modify characteristics of the input electrical energy, a regulator configured to receive a supply voltage based on the input electrical energy and generate an output voltage, and a controller configured to control characteristics of the input electrical energy to maximize power efficiency associated with at least one of the charging integrated circuit and the electronic device.

### RELATED APPLICATION

The present disclosure claims priority to U.S. Provisional Patent Application Ser. No. 63/239,669, filed Sep. 1, 2021, which is incorporated by reference herein in its entirety.

### FIELD OF DISCLOSURE

The present disclosure relates in general to circuits for electronic devices, including without limitation personal audio devices such as wireless telephones and media players, and more specifically, a power interface for maximizing efficiency of a power converter integral to such electronic devices.

### BACKGROUND

Portable electronic devices, including wireless telephones, such as mobile/cellular telephones, tablets, cordless telephones, mp3 players, smart watches, health monitors, and other consumer devices, are in widespread use. Such a portable electronic device may include a battery (e.g., a lithium-ion battery) for powering components of the portable electronic device. Typically, such batteries used in portable electronic devices are rechargeable, such that when charging, the battery converts electrical energy into chemical energy which may later be converted back into electrical energy for powering components of the portable electronic device.

A battery charging system often includes one or more power converters that may receive a power supply voltage (e.g., from an alternating current-to-direct current adapter plugged into a wall outlet) and convert such power supply voltage to a suitable voltage for charging a battery. For example, some charging systems employ a buck converter for receiving the power supply voltage and converting the power supply voltage to a charging voltage lower than the power supply voltage.

A disadvantage of inductive-based buck converters are that such converters may have a limited practical power conversion efficiency that worsens as the ratio of the power supply voltage to the charging voltage increases.

U.S. Pat. No. 10,411,490 describes controlling a Universal Serial Bus (USB) Power Delivery (PD) 3.0 Programmable Power Supply (PPS) conversion ratio of a switched capacitor converter, to maintain the regulator in a particular conversion mode to improve efficiency of the switched capacitor converter. U.S. Pat. No. 10,523,039 describes controlling a wireless power transfer system based on a conversion ratio of a switched capacitor converter, to maintain the system in a particular conversion mode to improve efficiency of the switched capacitor converter. U.S. Pat. No. 10,411,490 and U.S. Pat. No. 10,523,039 are incorporated by reference herein in their entireties. However, approaches to similarly improving systems with inductive-based buck converters are desired.

### SUMMARY

In accordance with the teachings of the present disclosure, one or more disadvantages and problems associated with existing approaches to battery charging may be reduced or eliminated.

In accordance with embodiments of the present disclosure, a charging integrated circuit for use in an electronic device may include an input interface configured to receive input electrical energy from a power supply, wherein the input interface is controllable to modify characteristics of the input electrical energy, a regulator configured to receive a supply voltage based on the input electrical energy and generate an output voltage, and a controller configured to control characteristics of the input electrical energy to maximize power efficiency associated with at least one of the charging integrated circuit and the electronic device.

In accordance with these and other embodiments of the present disclosure, a method may include, in a system having an input interface configured to receive input electrical energy from a power supply, wherein the input interface is controllable to modify characteristics of the input electrical energy, and further having a regulator configured to receive a supply voltage based on the input electrical energy and generate an output voltage, controlling characteristics of the input electrical energy to maximize power efficiency associated with at least one of the charging integrated circuit and the electronic device.

In accordance with these and other embodiments of the present disclosure, an electronic device may include a battery and a charging integrated circuit for charging the battery. The charging integrated circuit may include an input interface configured to receive input electrical energy from a power supply, wherein the input interface is controllable to modify characteristics of the input electrical energy, a regulator configured to receive a supply voltage based on the input electrical energy and generate an output voltage, and a controller configured to control characteristics of the input electrical energy to maximize power efficiency associated with at least one of the charging integrated circuit and the electronic device.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an example system for charging a battery of an electronic device, in accordance with embodiments of the present disclosure;

FIG. 2 illustrates another example system for charging a battery of an electronic device, in accordance with embodiments of the present disclosure;

FIG. 3 illustrates yet another example system for charging a battery of an electronic device, in accordance with embodiments of the present disclosure;

FIG. 4 illustrates yet another example system for charging a battery of an electronic device, in accordance with embodiments of the present disclosure;

FIG. 5A illustrates operational sequences of an example three-level buck converter in which an output voltage of the three-level buck converter is less than one-half of its input voltage, in accordance with embodiments of the present disclosure; and

FIG. 5B illustrates operational sequences of an example three-level buck converter in which an output voltage of the three-level buck converter is more than one-half of its input voltage, in accordance with embodiments of the present disclosure.

### DETAILED DESCRIPTION

High current and high final-voltage charging of lithium-ion batteries often requires fine control of a battery charging current and voltage. Such control is often preferably handled by including an inductive charging integrated circuit local to the battery.

In the methods and systems disclosure herein, a power supply interface may be controlled such that an input supply voltage provided to a charger or power converter (e.g., a switched inductor charger/converter) is maintained at its lowest practical input supply voltage, with the result that the ratio of the input supply voltage to the charging voltage generated by the charger/power converter is maintained at a practical minimum. Because the efficiency of the power converter is a function of such ratio, system efficiency may accordingly be optimized. In some embodiments, minimizing the input supply voltage may be accomplished by using a variable output voltage from a USB PPS adapter to fine tune the input supply voltage received by the charger/power converter. In addition or alternatively, minimizing the input supply voltage may be accomplished by controlling a suitable wireless power transfer interface to provide the most efficient level of input supply voltage to the charger/power converter.

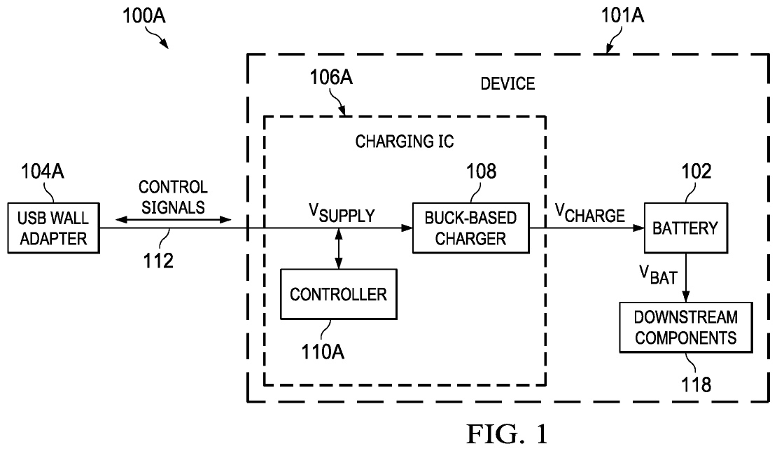

FIG. 1 illustrates an example system 100A for charging a battery 102 of an electronic device 101A, in accordance with embodiments of the present disclosure. As shown in FIG. 1, system 100A may include device 101A and a USB wall adapter 104A serving as a power supply.

Device 101A may be any suitable electronic device, including without limitation a mobile phone, smart phone, tablet, laptop/notebook computer, media player, handheld, gaming controller, etc. As shown in FIG. 1, device 101A may include a battery 102, one or more downstream components 118 powered from battery 102, and a charging integrated circuit (IC) 106A for charging battery 102.

Battery 102 may include any system, device, or apparatus configured to convert chemical energy stored within battery 102 to electrical energy. For example, in some embodiments, battery 102 may be integral to a portable electronic device and battery 102 may be configured to deliver electrical energy to downstream components 118 of device 101A. Further, battery 102 may also be configured to recharge, in which it may convert electrical energy received by battery 102 from charging IC 106A into chemical energy to be stored for later conversion back into electrical energy. As an example, in some embodiments, battery 102 may comprise a lithium-ion battery.

Downstream components 118 may include any suitable functional circuits or devices of device 101A, including without limitation power systems (e.g., voltage regulators, power converters, etc.), processors, audio coder/decoders, amplifiers, display devices, audio transducers, etc. As shown in FIG. 1, downstream components 118 may be powered from battery voltage V_{BAT} generated by battery 102.

Charging IC 106A may include any system, device, or apparatus configured to, when device 101A is coupled to USB wall adapter 104A (e.g., via USB cable 112), receive control signals and electrical energy from USB wall adapter 104A and control delivery of such energy to battery 102. As shown in FIG. 1, charging IC 106A may include a buck-based charger 108 and a controller 110A.

Buck-based charger 108 may include any system, device, or apparatus configured to, when device 101A is coupled to USB wall adapter 104A, receive supply voltage V_{SUPPLY} from USB wall adapter 104A and convert supply voltage V_{SUPPLY} to a charging voltage V_{CHARGE} smaller in magnitude than supply voltage V_{SUPPLY} Buck-based charger 108 may communicate such charging voltage V_{CHARGE} to battery 102 in order to charge or recharge battery 102. In certain embodiments, buck-based charger 108 may include an inductive buck converter comprising an inductor and one or more switches for performing the buck-based functionality of buck-based charger 108. However, any suitable regulator may be used to implement buck-based charger 108, including without limitation a switched-capacitor regulator, a hybrid regulator, and a multi-level regulator.

Controller 110A may include any system, device, or apparatus configured to, when device 101A is coupled to USB wall adapter 104A, receive control signals from USB wall adapter 104A and/or communicate control signals to USB wall adapter 104A and based on such control signals, control delivery of energy from USB wall adapter 104A to buck-based charger 108 and delivery of energy from buck-based charger 108 to battery 102. In particular, controller 110A may select a voltage level of supply voltage V_{SUPPLY} and cause USB wall adapter 104A to supply such selected voltage level, in order to maximize efficiency of buck-based charger 108, as described in greater detail below.

USB wall adapter 104A may include any suitable adapter configured to supply electrical energy to device 101A in the form of supply voltage V_{SUPPLY} (e.g., a relatively constant direct current or DC voltage) from which buck-based charger 108 may charge battery 102 when device 101A is coupled to USB wall adapter 104A. For example, in some embodiments, USB wall adapter 104A may include an alternating current (AC)-to-DC converter/adapter, configured to convert an AC voltage (e.g., provided by an electrical socket installed in the wall of a building) into a DC voltage. Further, USB wall adapter 104A may be configured to generate supply voltage V_{SUPPLY} and at a selected voltage level selected from a plurality of discrete selectable voltage levels.

In operation, when device 101A is coupled to USB wall adapter 104A, USB wall adapter 104A may communicate to controller 110A the selectable voltage levels of USB wall adapter 104A. In response, and based on charging voltage V_{CHARGE} to be provided to battery 102 and any other suitable parameters, controller 110A may select from the selectable voltage levels the selected voltage level in order to maximize efficiency of buck-based charger 108 by selecting the smallest selectable voltage level that may allow system 100A to maintain all other electrical requirements. Once controller 110A has selected the selected voltage level, controller 110A may communicate such selection to USB wall adapter 104A, and USB wall adapter 104A may generate such selected voltage level for supply voltage V_{SUPPLY} in response.

As an illustrative example, assume USB wall adapter 104A has selectable voltage levels of 5 volts, 9 volts, 15 volts, or 20 volts and buck-based charger 108 is to generate charging voltage V_{CHARGE} at 4 volts to battery 102. In response to receiving such selectable voltage levels from USB wall adapter 104A, controller 110A may determine that the selectable voltage of 5 volts is sufficiently high to enable buck-based charger 108 to generate charging voltage V_{CHARGE} at 4 volts; however such selectable voltage of 5 volts may be too small to meet an overcurrent limit for USB wall adapter 104A, device 101A, and/or cable 112 (e.g., as current delivered by USB wall adapter 104A may be inversely proportional to supply voltage V_{SUPPLY}) Accordingly, controller 110A may select the lowest possible selectable voltage level (e.g., 9 volts) that satisfies overcurrent restraints (or other electrical constraints) of USB wall adapter 104A, device 101A, and/or cable 112. Such selection of the lowest possible selectable voltage level may result in the highest power efficiency for operation of buck-based charger 108.

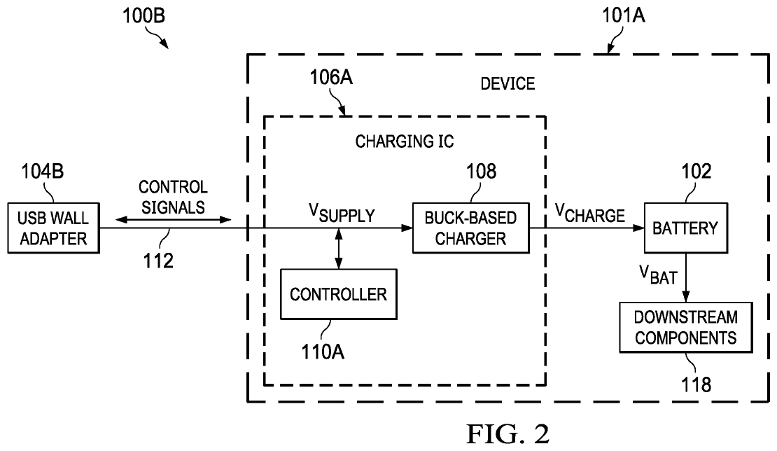

FIG. 2 illustrates an example system 100B for charging battery 102 of electronic device 101A, in accordance with embodiments of the present disclosure. As shown in FIG. 2, system 100B may include device 101A and a USB wall adapter 104B serving as a power supply. System 100B of FIG. 2 may be similar in many respects to system 100A of FIG. 1, and thus, only certain differences between system 100A and system 100B may be discussed below. In particular, the main difference between system 100A and system 100B is that system 100B may include USB wall adapter 104B in lieu of USB wall adapter 104A.

USB wall adapter 104B may differ from USB wall adapter 104A in that USB wall adapter 104B may comprise a USB PPS having significantly more selectable voltages that have significantly more granularity than the selectable voltages of USB wall adapter 104A. Thus, instead of having only a small number of discrete selectable voltages (e.g., 5 volts, 9 volts, 15 volts, or 20 volts), USB wall adapter 104B may include numerous selectable voltages over a wide range of voltages (e.g., between 3 volts and 21 volts in increments of 100 millivolts). Thus, while not technically capable of selecting a selected voltage from a continuous range of voltages, from a practical standpoint, the selected voltage for USB wall adapter 104B may be considered to be selected from a continuous range of voltages given the small granularity of selectability.

In operation, when device 101A is coupled to USB wall adapter 104B, USB wall adapter 104B may communicate to controller 110A that it is a USB PPS, which communication may include its range of selectable voltages and the granularity within such range. In response, and based on charging voltage V_{CHARGE} to be provided to battery 102 and any other suitable parameters, controller 110A may select the selected voltage level in order to maximize efficiency of buck-based charger 108 by selecting the smallest selectable voltage level that may allow system 100B to maintain all other electrical requirements. Once controller 110A has selected the selected voltage level, controller 110A may communicate such selection to USB wall adapter 104B, and USB wall adapter 104B may generate such selected voltage level for supply voltage V_{SUPPLY} in response.

As an illustrative example, assume USB wall adapter 104B has a voltage range of 3 volts to 21 volts at steps of 100 millivolts and buck-based charger 108 is to generate charging voltage V_{CHARGE} at 4 volts to battery 102. In response to receiving an indication from USB wall adapter 104B that USB wall adapter 104B is USB PPS enabled and/or an indication of the range of and granularity for the selected voltage level, controller 110A may select the lowest possible selectable voltage level (e.g., 4.1 volts) that satisfies voltage headroom requirements for buck-based charger 108 and overcurrent restraints (or other electrical constraints) of USB wall adapter 104B, device 101A, and/or cable 112. Such selection of the lowest possible selectable voltage level may result in the highest power efficiency for operation of buck-based charger 108.

However, it is noted that selection from the plurality of selectable voltage levels may be based on an optimization of one or more parameters which may not necessarily result in the highest power efficiency for operation of buck-based charger 108. For example, selection of a selectable voltage level may be made to optimize (i e , minimize) input and/or output ripple currents, may be made to optimize overall power efficiency of system 100B, may be based on battery state of charge, may be based on allowable switching frequencies of buck-based charger 108, and/or may be based on any other parameters in addition to or in lieu of optimizing efficiency for operation of buck-based charger 108. In particular, the use of variable ratio buck-based charger 108, which may generate an output voltage from an input voltage by appropriately controlling the switching duty cycle of buck-based charger 108, means that buck-based charger 108 may be able to generate a desired supply voltage V_{SUPPLY} regardless of charging voltage V_{CHARGE}, as along as V_{CHARGE}>V_{SUPPLY}. Accordingly, controller 110A may select a value for charging voltage V_{CHARGE} to satisfy other requirements and/or optimize other operational parameters.

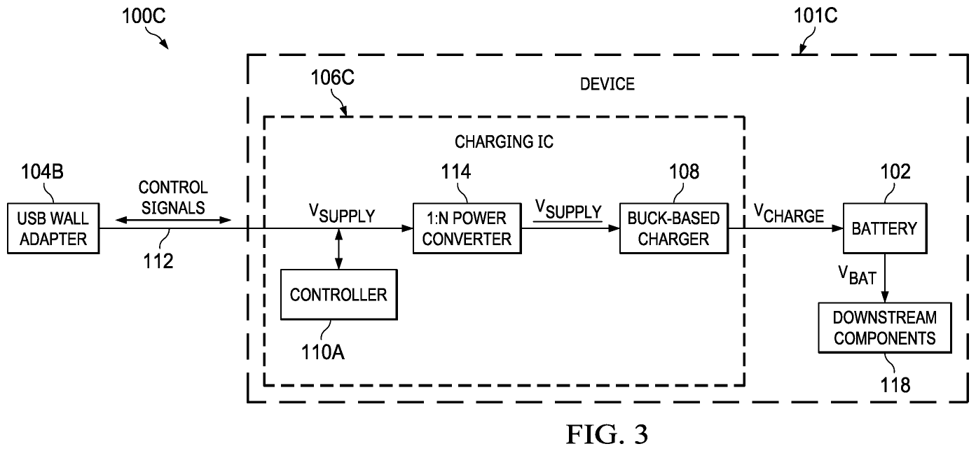

FIG. 3 illustrates an example system 100C for charging battery 102 of electronic device 101C, in accordance with embodiments of the present disclosure. As shown in FIG. 3, system 100C may include a device 101C and a USB wall adapter 104B serving as a power supply. System 100C of FIG. 3 may be similar in many respects to system 100B of FIG. 2, and thus, only certain differences between system 100B and system 100C may be discussed below.

In particular, the main difference between system 100B and system 100C is that system 100C may include charging IC 106C in lieu of charging IC 106A. Further, charging IC 106C of FIG. 3 may be similar in many respects to charging IC 106A of FIG. 2, and thus, only certain differences between charging IC 106A and charging IC 106C may be discussed below. The main difference between charging IC 106A and charging IC 106C is that charging IC 106C may include a 1:N power converter 114 interfaced between buck-based charger 108 and (when device 101C is coupled to USB wall adapter 104B) USB wall adapter 104B. In operation, 1:N power converter 114 may be configured to convert supply voltage V_{SUPPLY} received at its input to an intermediate voltage V_{SUPPLY}/N provided to the input of buck-based charger 108. Factor N may be designed to have any suitable positive value, and in some embodiments may be limited to an integer.

In operation, when device 101C is coupled to USB wall adapter 104B, USB wall adapter 104B may communicate to controller 110A that it is a USB PPS, which communication may include its range of selectable voltages and the granularity within such range. In response, and based on charging voltage V_{CHARGE} to be provided to battery 102 and any other suitable parameters, controller 110A may select the selected voltage level in order to maximize efficiency of buck-based charger 108 by selecting the smallest selectable voltage level that may allow system 100C to maintain all other electrical requirements. In particular, such selected voltage level of USB wall adapter 104B may be N times larger than a voltage required to ensure that buck-based charger 108 generates the desired charging voltage V_{CHARGE} to battery 112. Once controller 110A has selected the selected voltage level, controller 110A may communicate such selection to USB wall adapter 104B, and USB wall adapter 104B may generate such selected voltage level for supply voltage V_{SUPPLY} in response. Thus, one advantage of charging IC 106C over charging IC 106A is that it may enable selection of higher voltage levels for supply voltage V_{SUPPLY} (e.g., in order to satisfy overcurrent and/or other electrical constraints) while still minimizing the ratio of intermediate voltage V_{SUPPLY}/N to charging voltage V_{CHARGE} to be small as possible.

As an illustrative example, assume USB wall adapter 104B has a voltage range of 3 volts to 21 volts at steps of 100 millivolts and buck-based charger 108 is to generate charging voltage V_{CHARGE} at 4 volts to battery 102. In response to receiving an indication from USB wall adapter 104B that USB wall adapter 104B is USB PPS enabled and/or an indication of the range of and granularity for the selected voltage level, controller 110A may select the lowest possible selectable voltage level (e.g., 4.1×N volts) that satisfies voltage headroom requirements for buck-based charger 108 and overcurrent restraints (or other electrical constraints) of USB wall adapter 104B, device 101C, and/or cable 112. Such selection of the lowest possible selectable voltage level may result in the highest power efficiency for operation of buck-based charger 108.

Although only a single 1:N power converter 114 is depicted in FIG. 3 for purposes of clarity and exposition, it is understood that in some embodiments, a plurality of power converters similar or identical to 1:N power converter 114 may be arranged in series and interfaced between buck-based charger 108 and (when device 101C is coupled to USB wall adapter 104B) USB wall adapter 104B.

Again, it is noted that selection from the plurality of selectable voltage levels may be based on an optimization of one or more parameters which may not necessarily result in the highest power efficiency for operation of buck-based charger 108. For example, selection of a selectable voltage level may be made to optimize (i e , minimize) input and/or output ripple currents, may be made to optimize overall power efficiency of system 100C, may be based on battery state of charge, may be based on allowable switching frequencies of buck-based charger 108, and/or may be based on any other parameters in addition to or in lieu of optimizing efficiency for operation of buck-based charger 108. In particular, the use of variable ratio buck-based charger 108, which may generate an output voltage from an input voltage by appropriately controlling the switching duty cycle of buck-based charger 108, means that buck-based charger 108 may be able to generate a desired supply voltage V_{SUPPLY} regardless of charging voltage V_{CHARGE}, as along as V_{CHARGE}>V_{SUPPLY}. Accordingly, controller 110A may select a value for charging voltage V_{CHARGE} to satisfy other requirements and/or optimize other operational parameters.

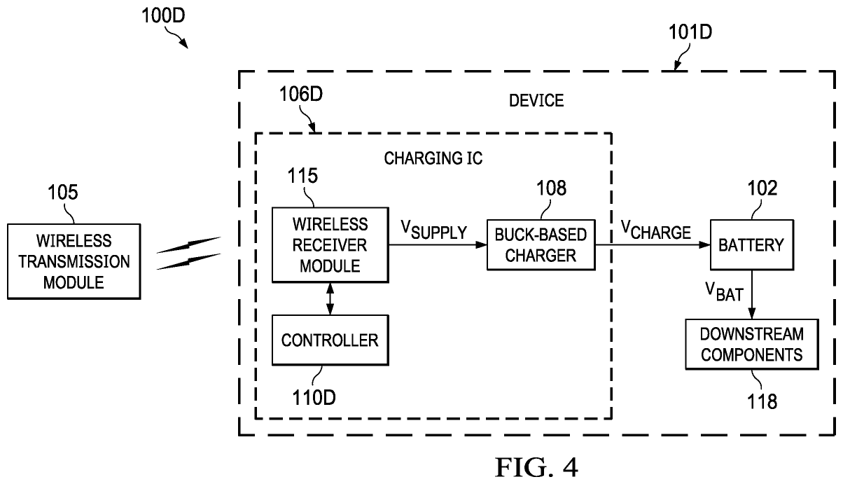

FIG. 4 illustrates an example system 100D for charging battery 102 of electronic device 101D, in accordance with embodiments of the present disclosure. As shown in FIG. 4, system 100D may include device 101D and a wireless transmission module 105. System 100D of FIG. 4 may be similar in many respects to system 100B of FIG. 2, and thus, only certain differences between system 100B and system 100D may be discussed below.

In particular, the main difference between system 100B and system 100D is that system 100D may include charging IC 106D in lieu of charging IC 106A and that system 100D may include wireless transmission module 105 in lieu of USB wall adapter 104B. Further, charging IC 104D of FIG. 4 may be similar in many respects to charging IC 106A of FIG. 2, and thus, only certain differences between system charging IC 106A and charging IC 106D may be discussed below.

Wireless transmission module 105 may comprise any system, device, or apparatus configured to wirelessly transmit electrical energy (e.g., via inductive coupling) to a corresponding wireless receiver module (e.g., wireless receiver module 115 of charging IC 106D).

The main difference between charging IC 106A and charging IC 106D is that charging IC 106D may include a wireless receiver module 115 interfaced between buck-based charger 108 and (when device 101D is coupled to wireless transmission module 105) wireless transmission module 105. Another difference between charging IC 106A and charging IC 106D is that charging IC 106D may include a controller 110D in lieu of controller 110A configured to control operation of wireless receiver module 115.

Wireless receiver module 115 may comprise any system, device, or apparatus configured to wirelessly receive electrical energy (e.g., via inductive coupling) from a corresponding wireless transmission module (e.g., wireless transmission module 105). In the topology shown in FIG. 4, wireless receiver module 115 may receive electrical energy from wireless transmission module 105, and convert such energy in the form of supply voltage V_{SUPPLY}.

In operation, controller 110D may be configured to control wireless receiver module 115 such that the wireless power transmission from wireless transmission module 105 results in supply voltage V_{SUPPLY} being maintained at the lowest practical voltage for power efficient operation of charging IC 106D. In some embodiments, the lowest practical voltage for power efficient operation of charging IC 106D may not be at a voltage which is the maximum efficiency for buck-based charger 108. In such embodiments, determining the lowest practical voltage for power efficient operation of charging IC 106D may require a determination of which voltage levels of supply voltage V_{SUPPLY} allow for power-efficient operation of wireless transceiver module 115, and setting a voltage level for supply voltage V_{SUPPLY} that maximizes the overall power efficiency of wireless transceiver module 115 and buck-based charger 108 (as well as other components of device 101D).

Again, it is noted that selection from the plurality of selectable voltage levels may be based on an optimization of one or more parameters which may not necessarily result in the highest power efficiency for operation of buck-based charger 108. For example, selection of a selectable voltage level may be made to optimize (i e , minimize) input and/or output ripple currents, may be made to optimize overall power efficiency of system 100D, may be based on battery state of charge, may be based on allowable switching frequencies of buck-based charger 108, and/or may be based on any other parameters in addition to or in lieu of optimizing efficiency for operation of buck-based charger 108.

For some topologies, it is understood that the maximum power efficiency or minimum system loss may not occur where supply voltage V_{SUPPLY} is maintained at or near charging voltage V_{CHARGE}. In such topologies, other criteria may be used in addition to or in lieu of those described above in order to set supply voltage V_{SUPPLY}.

As a particular example, for a wireless power transmission system such as that shown in FIG. 4, the efficiency of power loss in transmit and receive coils of wireless transmission module 105 and wireless receiver module 115, respectively, may be optimized by increasing a wireless voltage transmitted from wireless transmission module 105 to a practical maximum, in order to minimize coil current. Accordingly, controller 110D may select supply voltage V_{SUPPLY} to minimize overall power losses in system 100D.

As another example, for a three-level power converter, the best efficiency for a given power level may occur at an optimum duty cycle within a switching element of buck-based charger 108. Accordingly, because the ratio of supply voltage V_{SUPPLY} to charging voltage V_{CHARGE} may be a function of such duty cycle, the smallest possible voltage for supply voltage V_{SUPPLY} may not be the most appropriate selection. To the contrary, in such a case, a controller may select a voltage level for supply voltage V_{SUPPLY} that leads to the optimum duty cycle and/or optimization of another parameter for such three-level converter.

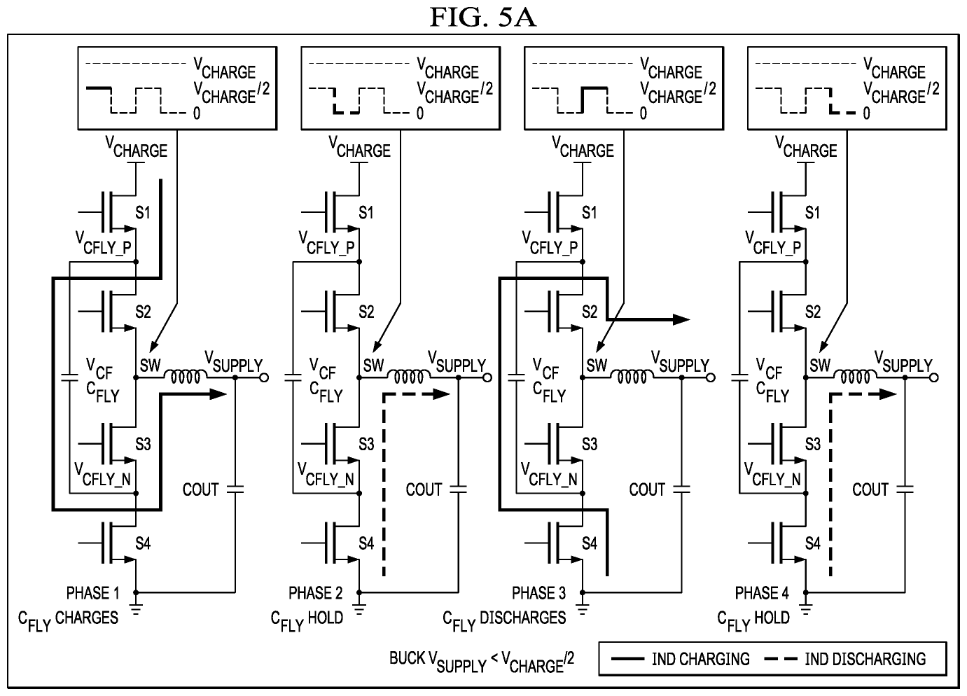

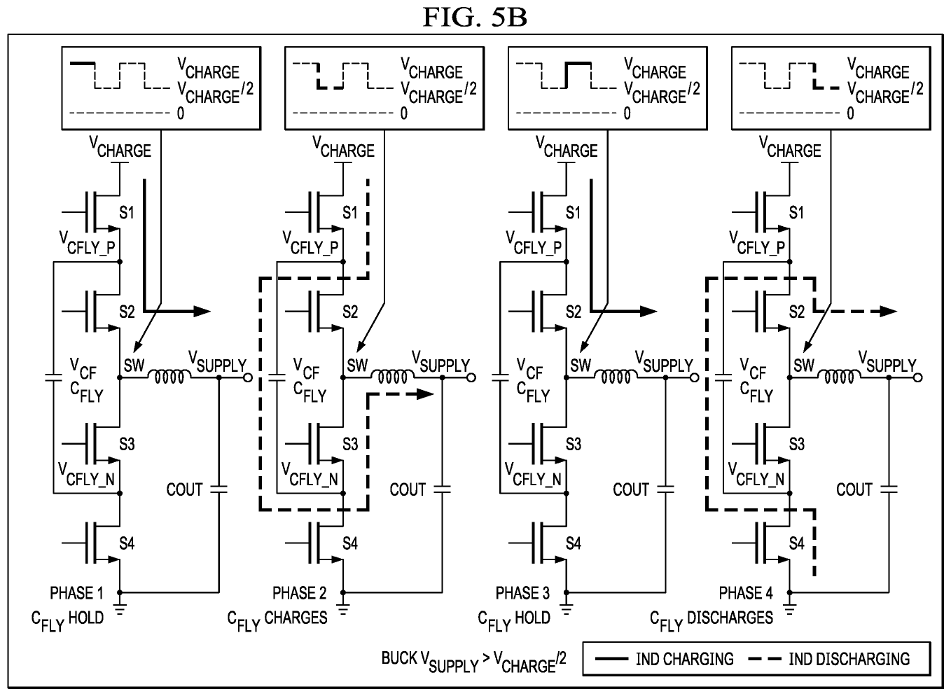

Such example may be illustrated with respect to FIGS. 5A and 5B, which depict operational sequences of a three-level buck converter in which supply voltage V_{SUPPLY} is less than V_{CHARGE}/2 (FIG. 5A) and in which supply voltage V_{SUPPLY} is greater than V_{CHARGE}/2 (FIG. 5B). Either sequence may be theoretically able to operate at exactly V_{SUPPLY}=V_{CHARGE}/2Vin/2, but control at this ratio may be challenging and may involve jumping from one sequence to the other. In order to optimize converter behavior (e.g., efficiency, ripple current, etc.) it may be preferable to either slightly increase or decrease charging voltage V_{CHARGE} in order to allow the converter to operate definitively in either the mode shown in FIG. 5A or the mode shown in FIG. 5B in order to simplify control, minimize switching losses, and/or minimize current ripple.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A charging integrated circuit for use in an electronic device, comprising:
an input interface configured to receive input electrical energy from a power supply, wherein the input interface is controllable to modify characteristics of the input electrical energy;
a regulator configured to receive a supply voltage based on the input electrical energy and generate an output voltage; and
a controller configured to control characteristics of the input electrical energy to maximize power efficiency associated with at least one of the charging integrated circuit and the electronic device.

2. The charging integrated circuit of claim 1, wherein the regulator comprises an inductive buck regulator.

3. The charging integrated circuit of claim 1, wherein the controller is configured to minimize the supply voltage in order to maintain an input voltage to output voltage ratio of the regulator at a maximum practical efficiency level.

4. The charging integrated circuit of claim 1, wherein the input interface comprises a Universal Serial Bus programmable power supply power interface.

5. The charging integrated circuit of claim 4, wherein the controller is configured to communicate with the power supply to control the power supply to deliver a desired selected voltage from the power supply in order to maximize power efficiency associated with at least one of the charging integrated circuit and the electronic device.

6. The charging integrated circuit of claim 1, wherein the input interface comprises an interface via which the controller is able to set a selected voltage level for a voltage delivered from the power supply, the selected voltage level selected from a plurality of voltage levels, and the controller is further configured to select the selected voltage level to maximize power efficiency associated with at least one of the charging integrated circuit and the electronic device.

7. The charging integrated circuit of claim 1, wherein the input interface comprises a wireless power transfer system, and the controller is further configured to control a wireless transmission module coupled to the charging integrated circuit via the input interface to cause the wireless transmission module to transmit a desired voltage to a wireless receiver module of the charging integrated circuit in order to maximize power efficiency associated with at least one of the charging integrated circuit and the electronic device.

8. The charging integrated circuit of claim 1, further comprising one or more power converters interfaced between the input interface and the regulator, such that the one or more power converters convert a voltage received from the power supply into the supply voltage.

9. The charging integrated circuit of claim 8, wherein the controller is further configured to control the voltage received from the power supply in order to maintain an input voltage to output voltage ratio of the regulator at a maximum practical efficiency level.

10. The charging integrated circuit of claim 1, wherein the controller is further configured to control characteristics of the input electrical energy to maximize power efficiency associated with at least one of the charging integrated circuit and the electronic device while satisfying one or more other electrical constraints associated with at least one 0 of the charging integrated circuit and the electronic device.

11. The charging integrated circuit of claim 10, wherein the one or more other electrical constraints comprises a current limit for an electrical current driven from the power supply to the charging integrated circuit.

12. The charging integrated circuit of claim 10, wherein the one or more other electrical constraints comprises a ripple current associated with the electronic device.

13. A method comprising, in a charging integrated circuit having an input interface configured to receive input electrical energy from a power supply, wherein the input interface is controllable to modify characteristics of the input electrical energy, and further having a regulator configured to receive a supply voltage based on the input electrical energy and generate an output voltage:
controlling characteristics of the input electrical energy to maximize power efficiency associated with at least one of the charging integrated circuit and an electronic device housing the charging integrated circuit.

14. The method of claim 13, wherein the regulator comprises an inductive buck regulator.

15. The method of claim 13, further comprising minimizing the supply voltage in order to maintain an input voltage to output voltage ratio of the regulator at a maximum practical efficiency level.

16. The method of claim 13, wherein the input interface comprises a Universal Serial Bus programmable power supply power interface.

17. The method of claim 16, further comprising communicating with the power supply to control the power supply to deliver a desired selected voltage from the power supply in order to maximize power efficiency associated with at least one of the charging integrated circuit and the electronic device.

18. The method of claim 13, further comprising setting, via the input interface, a selected voltage level for a voltage delivered from the power supply, the selected voltage level selected from a plurality of voltage levels, wherein the selected voltage level is selected to maximize power efficiency associated with at least one of the charging integrated circuit and the electronic device.

19. The method of claim 13, wherein the input interface comprises a wireless power transfer system, and the method further comprises controlling a wireless transmission module coupled to the charging integrated circuit via the input interface to cause the wireless transmission module to transmit a desired voltage to a wireless receiver module of the charging integrated circuit in order to maximize power efficiency associated with at least one of the charging integrated circuit and the electronic device.

20. The method of claim 13, wherein one or more power converters are interfaced between the input interface and the regulator, such that the one or more power converters convert a voltage received from the power supply into the supply voltage.

21. The method of claim 20, further comprising controlling the voltage received from the power supply in order to maintain an input voltage to output voltage ratio of the regulator at a maximum practical efficiency level.

22. The method of claim 13, further comprising controlling characteristics of the input electrical energy to maximize power efficiency associated with at least one of the charging integrated circuit and the electronic device while satisfying one or more other electrical constraints associated with at least one of the charging integrated circuit and the electronic device.

23. The method of claim 22, wherein the one or more other electrical constraints comprises a current limit for an electrical current driven from the power supply to the charging integrated circuit.

24. The method of claim 22, wherein the one or more other electrical constraints comprises a ripple current associated with the electronic device.

25. An electronic device comprising:
a battery; and
a charging integrated circuit for charging the battery, the charging integrated circuit comprising:
an input interface configured to receive input electrical energy from a power supply, wherein the input interface is controllable to modify characteristics of the input electrical energy;
a regulator configured to receive a supply voltage based on the input electrical energy and generate an output voltage; and
a controller configured to control characteristics of the input electrical energy to maximize power efficiency associated with at least one of the charging integrated circuit and the electronic device.
